(19) United States
(12) Patent Application Publication
(10) Pub. No.: US 2018/0292890 A1
(43) Pub. Date: Oct. 11, 2018

(54) Using Detected User Activity to Modify Webpages and Other Client Presentations

(71) Applicant: AKI Technologies, Inc., San Francisco, CA (US)

(72) Inventors: Richard Scott Swanson, San Francisco, CA (US); Alvaro Bravo, San Francisco, CA (US); Carlos Mondragon, San Francisco, CA (US); James H. Finn, San Francisco, CA (US)

(21) Appl. No.: 15/948,954

(22) Filed: Apr. 9, 2018

Related U.S. Application Data
(60) Provisional application No. 62/483,260, filed on Apr. 7, 2017.

(51) Int. Cl. G06F 3/01; H04L 29/08; G06Q 30/02

(52) U.S. Cl. CPC G06F 3/011; H04L 67/02; G06Q 30/0269; H04L 67/22

(57) ABSTRACT

Embodiments of a feedback system can have sensors for sensing movement and other characteristics of user devices, analyze the sensor data for a user device to determine a current behavior of a user, and determine a characteristic of a presentation that can vary as a function of that behavior. For example, where the presentation is a website, if an analyzing program determines from the sensor data that a user is in a relatively inactive state, the website might be presented with full interactivity, whereas if the analyzing program determines from the sensor data that a user is busy with an activity, the website might be presented in a more abbreviated form.

### CROSS-REFERENCES TO PRIORITY AND RELATED APPLICATIONS

This application claims priority from and is a non-provisional of U.S. Provisional Patent Application No. 62/483,260 filed Apr. 7, 2017 entitled “Using Detected User Activity to Modify Webpages and Other Client Presentations”.

The entire disclosure(s) of application(s)/patent(s) recited above is(are) hereby incorporated by reference, as if set forth in full in this document, for all purposes.

### FIELD OF THE INVENTION

The present disclosure generally relates to a networked system that gathers sensor data from user devices and more particularly to apparatus and techniques for gathering sensor data from user devices, using machine processing to infer and categorize likely user activities from the sensor data, and then modify web displays and other presentations accordingly.

### BACKGROUND

Different formats for web-based or app-based presentations might be desired for different situations. For example, if someone is concentrating on watching a movie, having a banner advertisement pop up might be distracting. However, if someone is browsing a web page, a banner advertisement might not be distracting and might be of interest to the user. In various situations, a viewer might be more or less able to absorb information. For example, a user being presented with information, whether an advertisement, a web page, or other information, might be able to absorb more complicated presentations of information if they are focused on their display device whereas the user might need a simplified display if they are handling other tasks while viewing the information being displayed.

Sometimes, the complexity of a web page or other presentation is controlled entirely by noting the type of device the user is using. For example, a web page might have a regular presentation used for desktop computers and a simplified presentation used if the server serving the web page determines that the end user device is a small mobile display device, such as a smartphone. Thus, the server selects among multiple presentations according to information about the destination device.

One approach is to send presentations based on the features of the destination device. However, that can be limiting.

### SUMMARY

Embodiments of a feedback system can have sensors for sensing movement and other characteristics of user devices, analyze the sensor data for a user device to determine a current behavior of a user, and determine a characteristic of a presentation that can vary as a function of that behavior. For example, where the presentation is a website, if an analyzing program determines from the sensor data that a user is in a relatively inactive state, the website might be presented with full interactivity, whereas if the analyzing program determines from the sensor data that a user is busy with an activity, the website might be presented in a more abbreviated form.

The sensor data might comprise data relating to motion of the user device and be distilled to a motion label representing a presumed activity of the user while using the user device. The motion label might be one of a predetermined set of motion labels. Analyzing the sensor data might include a machine learning process to interpret the sensor data and external data to determine behavior of an audience. The external data might be data indicative of characteristics of a current environment of the user and/or the user device other than characteristics determined from sensors of the user device, such as weather data for a location indicated by a location sensor or program of the user device, map data indicative of a use of the location, or data indicative of a land type data of the location.

Embodiments of a presentation system can serve tailored presentations in a particular format to user devices that have sensors for sensing movement and other characteristics of the user devices can gather sensor data from the user devices, analyze the sensor data for a user device to determine an audience containing a user of that user device so that the user can be identified as a member of an audience of users sharing a particular profile based on their movements, select presentation format to present to that user based on the audience of the user. The presentation might include advertisements appropriate to the user.

The sensor data can be obtained at times other than just when a presentation is being presented. For example, code embedded in a prior presentation content can be used to gather the sensor data or code provided to application developers, such as in a system development kit, can obtain sensor data. In either case, the sensor data can be obtained without it being available to the application that executes the program code. That program code can be stored in non-transitory computer-readable storage medium available at the user device.

The sensor data, whether obtained at the moment or prior, might be used for determining how to present information to a user. For example, if the sensor data is processed to determine whether a user of a device is busy with some activity or not busy with some activity, the presentation of information might be altered. For example, the information of a website might be presented to the user in a simplified form if the sensor data indicates that the user is busy with some activity and/or presents the option to view the information at a later time. Similarly, if the sensor data is processed to indicate that the user is usually busy with other activities at a certain time, that can be used to infer that the user is busy and a presentation such as a web page is tailored accordingly.

Embodiments of a feedback system can have sensors for sensing movement and other characteristics of user devices, analyze the sensor data for a user device to determine a current behavior of a user, and determine a characteristic of a presentation that can vary as a function of that behavior. For example, where the presentation is a website, if an analyzing program determines from the sensor data that a user is in a relatively inactive state, the website might be presented with full interactivity, whereas if the analyzing program determines from the sensor data that a user is busy with an activity, the website might be presented in a more abbreviated form.

Embodiments might be in the form of a non-transitory computer-readable storage medium having stored thereon executable instructions that, when executed by one or more processors of a computer system, cause the computer system to perform some or all of the steps of such processes. The code provided might include motion collection code, but might also include code for obtaining other sensor data or other data usable to determine appropriate audiences for a user.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 is a block diagram of a networked system that correlates user device sensor data with external data to derive a user activity and transmit to the user device selected advertisements based on the derived user activity.

FIG. 2 is a block diagram of another networked system wherein user devices are fitted with program code that collects sensor data that is independent of delivered advertisements.

FIG. 3 is a block diagram of yet another networked system, wherein program code observes motion data over a period of time that is used for selecting advertisements.

FIG. 4 is a block diagram of yet another networked system, wherein program code observes motion data over a period of time that is used for determining how to present information.

FIG. 5 is a block diagram of yet another networked system, wherein program code observes motion data over a period of time that is used for determining how to present information and provides details to a web server for varying how the presented information is sent.

FIG. 6 is a schematic of computer-readable elements of memory.

FIG. 7 is a block diagram of a computer processor that might be used for various elements illustrated elsewhere.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

As used herein, a “user device” refers to an electronic device capable of interacting with a person, the “user,” who owns, operates and/or controls the electronic device. The user device is also capable of local computations, storing program code, executing that program code using a processor, presenting content to the user, accepting inputs from the user and sensing physical measurements of the user device, such as its movements, accelerations, rotations and other related measurements. The user device preferably has an ability to communicate with remote servers and other devices.

Sensors available on the user device or used with the user device might include a gyroscope sensor for detecting and/or measuring rotation, an accelerometer for detecting and/or measuring movement, a GPS element for detecting and/or measuring location, a barometer for detecting and/or measuring atmospheric pressure, a thermometer for detecting and/or measuring temperature, a magnetometer (e.g., a compass), a proximity sensor (for detecting how close objects are to detect, for example, if a person is using the phone), and similar or different sensors.

Sensor data can be collected, using various mechanisms, at the user device and provided to the backend server, which then distills that sensor data into motion labels or user activities. For example, the sensor data might be collected by program code that runs as part of an SDK that is provided to app developers. Thus, when the user installs an app from one of those app developers on their user device and the user device executes that app, the code of the app would collect that sensor data (assuming the user has given permission for such data collection) and provide that data to the backend server. The results from the backend server can be used for ad targeting, fraud detection, webpage formatting, or other purposes acceptable to the user. Various sensors can provide sensor data.

Where the user device includes a barometric sensor, i.e., a sensor that senses a current atmospheric pressure, it can be one of the sensors that generate this sensor data. The barometric sensor of a user device might sometimes be used for location detection in that a measured atmospheric pressure can be representative of an altitude where the user device is currently located. The barometric sensor data could be useful, for example, in deciding on what ad targeting to do. For example, if the atmospheric pressure or a change in the atmospheric pressure is sensed, perhaps an advertisement for umbrellas might be targeted. As another example, if the sensor data has been processed to indicate that the user is likely out jogging and the barometric sensor data suggests an imminent tornado, the user device might take some action based on that data.

Communication might be wireless or over wires, with remote servers and other network-connected equipment. A network-connected server might comprise server hardware including a processor that executes server program code and/or database management program code stored in program memory accessible to the processor.

A database management system might maintain databases and/or access storage where databases are stored, to accept data writes and data modifications, as well as responding to requests for data to be read from such databases.

In addition to varying a presentation format, a networked system might provide for advertisements to be inserted into slots of apps or web pages. The user device provides sensor data (motion, position, acceleration, location, etc.) that is used to select the appropriate advertisements for applications on that user device. The selection might be done directly from the sensor data or instead the sensor data may be used to categorize the user of a user device into an audience, and advertisements targeting that audience may be served to that user device and similarly situated user devices. An audience is a collection of users that share some determined profile, such as an audience of restaurant enthusiasts, an audience of skiers, an audience of needle workers, an audience of cyclists, an audience of regular library visitors, or the like.

In determining an audience, or audiences for a user of a particular user device, an ad backend server might take sensor data from the user device and combine it with external data. The backend server might use a machine learning process to interpret the sensor data with the external data to determine a likely audience for that user device. Examples of external data might include weather data (e.g., it was raining that day at this location), land use data (e.g., this land is a ski resort, this land is used for music festivals on this particular day), land type data (this is urban, this is water), etc. As an example, with the user's permission, the user device might provide sensor data to indicate that on a particular day, the user was moving in a dancing way at a particular GPS location, and the external data provides that at that date and location, there was a music festival, which the networked system can use to process actions of the user to identify appropriate ads. As another example, based on the sensor data and land use data, the networked system can determine that the user device is owned by a user who is in the skier audience (noting the motion of a person skiing while their GPS location matches ski slopes). It might be the case that the format for a webpage changes so that the background is a different color depending on the weather data, where contrast and brightness and background color are adjusted based on what the system determines the weather to be. For example, on a sunny day when the user is deemed to be skiing, webpage colors might adjust for the sun and for the color changes caused by ski goggles.

After users give the networked system access to sensors, the user device would collect this sensor data using embedded code that the system operator provides to advertising-supported app developers, such as by providing them with a software development kit (SDK). The app developers may then include the SDK-provided code that performs the sensor data processing, while keeping that isolated from the application. In another approach, the sensor data collecting code is included as a JavaScript™ fragment delivered with an advertisement that is executed by a mobile device browser, for example. When supplying the code as part of an advertisement, the code passes through ad exchanges that are supplying advertising-supported apps with advertisements.

Users are associated with audiences, and prior data about users can be prestored so that the audiences a user belongs to are known. In other variations, the audience is determined more in real time, where the embedded code is able to observe motion over a period of time, such as a 1 second span to a 10 minute span, and from that observation, an audience can be determined or inferred before sending an advertisement. Audience data and ads served can be stored for later analysis and audience creation. The sensor data can be recorded at the user device for later transmission to an ad backend server. The recorded sensor data might be stored in memory, possibly in a memory space not accessible by other program code on the user device, or otherwise in a manner not accessible by the other program code on the user device.

Aside from making audience and advertising decisions, the user device can also supply sensor data to a backend server and have the backend server determine an activity, an activity level, or a deemed attentiveness level for the user of the user device. Labels, tags, etc. for this determination of activity level or deemed attentiveness measure can be provided to the user device and then, when requesting online resources such as webpages, the user device would include with a request the labels/tags/etc. to a content server such as a website web server. In that manner, the content server can tailor the content based on the activity, activity level, or deemed attentiveness measure. The content server can obtain those labels/tags/etc. in the request from the user device, but in another embodiment, sensor or motion data is supplied with the request and the content server makes a request to the backend server to process the sensor or motion data and return the corresponding labels/tags/etc. In either case, when the content server is providing the content, the content can be formatted differently based on differences in the labels/tags/etc.

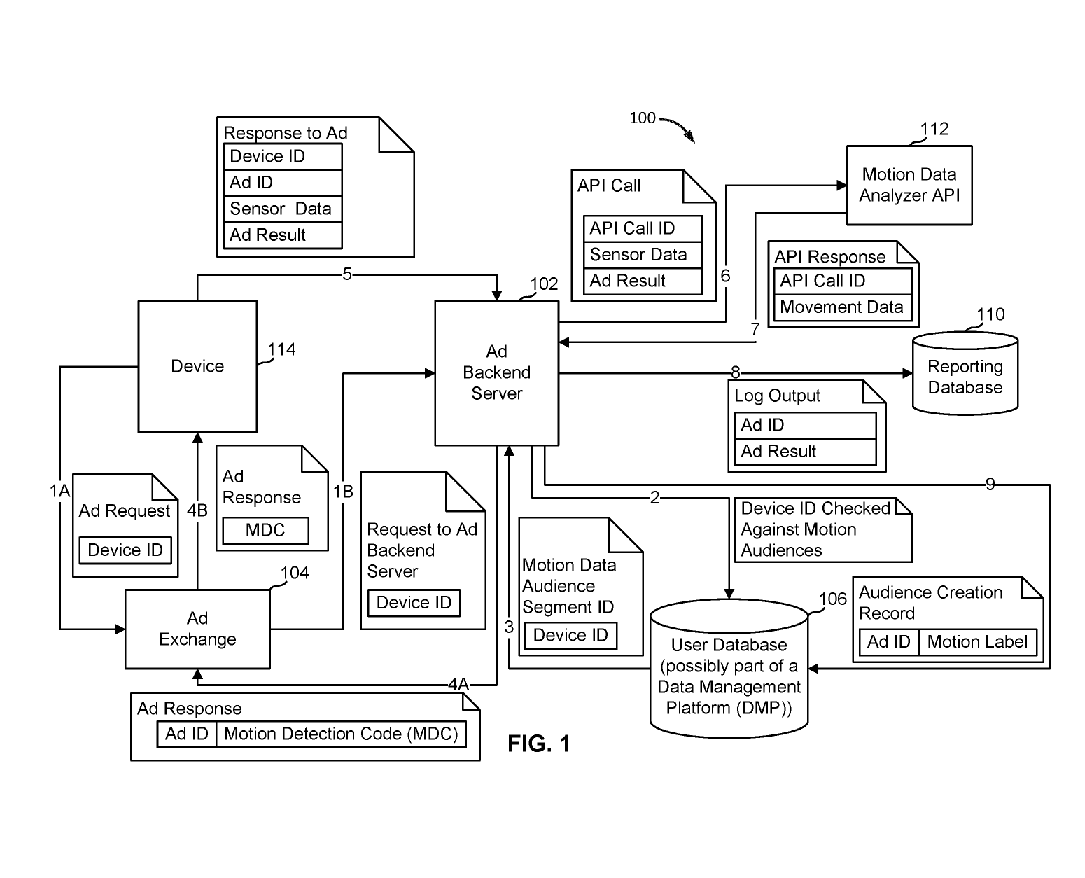

FIG. 1 is a block diagram of a networked system that correlates user device sensor data with external data to derive a user activity and transmit to the user device selected advertisements based on the derived user activity. The advertisements might contain motion detection code that creates sensor data that is included in a response to the ad. The networked system might comprise network-connected servers, user devices and databases. In these examples, where only one instance of an object is shown, it should be understood that there might be multiple such instances, unless otherwise indicated.

A derived user activity might be determined from (a) a detection of a movement type of the user (e.g., walking, running, skiing, driving, etc.), (b) a detection of a location of the user device (e.g., in the user's hand, in the user's pocket, resting on a horizontal surface such as a table, etc.), and (c) a detection of a current user activity (e.g., none, handling, typing, etc.). This derived user activity can be determined from raw sensor data from the user device, and those determinations can be done on the device, on a central ad backend server that handles other tasks, or can be done using a dedicated service that analyzes sensor data to determine user activity. Derived user activity might be determined based on one-time sensor readings or readings over time.

This information can then be used to determine a presentation of a web page or of an app user interface. For example, if it is determined that a user is running and from this it is determined that the user's deemed attentiveness measure is low, a prompt may be popped up asking if the user would like to visit the web page or app later, such as after their run. If it is determined the user's deemed measure of attentiveness is medium, a simplified user interface may be provided. In one embodiment, a web page or app interface may be provided before the deemed measure of attentiveness is available. Once the deemed measure of attentiveness indicates the user is in a lower level of attentiveness, the user interface may, for example, flash and offer to provide a simplified user interface more fitting to the deemed measure of attentiveness. In another embodiment, the deemed measure of attentiveness is available before the web page or user interface is presented, allowing the initial presentation to be tailored to the deemed measure of attentiveness. In another embodiment, the user's activity may be used to add the user to an audience. For example, if it determined that the user is running and location data indicates an organized marathon is going on where the user is, the user can be added to a “runners” audience.

As shown in FIG. 1, a networked system 100 comprises an ad backend server 102, interfaces to an ad exchange server 104, a user database 106, a reporting database 110 and a motion data analyzer 112 (which might be accessed by ad backend server 102 via an API). Ad backend server 102 might also handle ad campaigns, ad bidding, and ad serving. For ad bidding, an app on the user device or an ad exchange in communication with the app might send a conditional request for an ad to ad backend server 102, upon which ad backend server 102 and the app or ad exchange would negotiate for the cost to place an ad. If ad backend server 102 determines that the terms of serving an ad are not agreeable, ad backend server 102 could decline to provide an ad response in response to the ad request. Also shown is a user device 114, which is an end user device. Although only one is shown, it should be understood that networked system 100 can handle many user devices simultaneously.

In a particular process, indicated by the numbered arrows in FIG. 1, data elements are passed among the components of networked system 100. The data elements passed between components can comprise the data indicated and possibly other data. The data might be passed in messages, API calls, writing to shared memory, or other methods of interprocess and/or inter-component communications. A process might start with flow 1. Flow 1 comprises two parts, flow 1A where the ad request is sent to an interface for ad exchange server 104 and a flow 1B where the ad request is sent from ad exchange server 104 to ad backend server 102. First, the user device 114 sends a request for an advertisement to an ad exchange server 104. This ad exchange server 104 might be operated independently of networked system 100 and thus networked system 100 will need to take into account constraints imposed by that independence, such as not having control over the structure and operations and data of ad exchange server 104.

When user device 114 requests an advertisement, the request would include a device ID, which would distinguish the requesting user device from other user devices that might also connect to ad exchange server 104. A user device might make a request for an advertisement because the user device is executing an advertiser-supported application or a browser with web pages having slots for advertisements. In some instances, the advertiser-supported application makes requests for advertisements independent of the design of the application. For example, many different advertiser-supported applications might use the same ad exchange server. In such cases, the request in flow 1 might also identify the advertiser-supported application, so that the ad exchange server can take that information into account in selecting the ad to serve up and also to track credits to application providers.

In flow 2, ad backend server 102 sends a query on user database 106 to determine if there are records for the user device identified in the request in flow 1. If not, records might be created. If there are records for that user device, the records would include details of one more motion audiences associated with the user device. An association of a user device (or some anonymized reference to the user device) might be formed from a history of motion of that user device. The mapping of users based on motion and other information to audiences might be done based on a set of rules that are stored in computer-readable form. For example, it might have been determined that beer ads are more frequently clicked during hotter weather whereas hot tea sells better during colder weather. Thus the ruleset might contain computer-readable rules such as “if user's current outdoor temp is less than X, put them in the tea drinking audience” and “if user's current outdoor temp is more than X, put them in the beer drinking audience.” These rules might be obtained empirically from human observation and encoded into the ruleset or some rules might occur from data analysis.

Based on previously gathered sensor data, a profile of the user of the user device is made by mapping raw sensor data to motion categories or labels, and possibly using external data as well. For example, ad backend server 102 might provide motion data analyzer 112 with sensor-based raw motion data that motion data analyzer 112 returns as being characterized as skiing motions, so then ad backend server 102 would store with the user record for that device in user database 106 a field indicator indicating that the user device is in the “skier” audience comprising users IDs associated with user devices that provided similar data, such as sensor data indicating hours of side-to-side movements during time periods that overlap time periods during which the location sensors (GPS, etc.) of the user devices reported locations that the networked system externally (outside of the user devices) determined are locations corresponding to ski resorts.

In flow 3, ad backend server 102 obtains audience segment data from the response to the query of user database 106 in flow 2. The reply data indicates the audience segments for the queried user ID. The reply may include a device ID to allow the ad backend server to match responses to requests, or anther mechanism of matching responses to requests may be used. In flow 4, ad backend server 102 sends a message to user device 114 (via ad exchange server 104, hence the flows 4A and 4B) comprising an advertisement in the form of electronic content. This flow 4 appears to user device 114 as a response to the request in flow 1. Ad backend server 102 selects the ad from among possible ads using campaign rules stored in computer-readable form. The campaign rules select ads based on processes that determine the one or more audiences to which the user device belongs. Under some conditions, ad backend server 102 might determine that it does not want to incur costs associated with an ad placement and does not return an ad. In those cases, the ad response in flow 4A might be a message indicating that an ad is not going to be supplied or a message indicating a default ad.

The message in flow 4 includes the advertisement content, which might be text, an animation, video, interactive program, etc. The message may also contain motion detection code, which is a snippet of code for motion measuring. This snippet might be an HTML/MRAID code portion that contains JavaScript™ code. As an ad is provided to the user device, the user device will execute the code.

Once the advertisement message is received by user device 114, user device 114 can use the advertisement, such as by placing it into an advertising slot of the requesting app, where the result might be a banner advertisement inside the requesting app. In the process of using the advertisement, user device 114 will execute the motion measuring snippet of code. The code snippet then causes a message to be transmitted, as flow 5, to ad backend server 102. That message contains the user device identifier (device ID), the sensor data (motion data and possibly other sensor data) when the advertisement was being displayed, and an identifier of the advertisement (Ad ID). It may also contain an ad result. The “ad result” data element might be a metric representing whether a user clicked on the ad, which can be representative of, or a proxy for, a measure of engagement. The sensor data might be stored as a hash table that is then compiled into a protocol buffer or other data structure for serializing structured data. The data structure containing the sensor data might be created by user device 114 using the JavaScript™ portion of the ad or it could also be generated by SDK code in user device 114.

Flow 6 might be an API call with arguments of an API call ID, sensor data, and an ad result record. The data sent to motion data analyzer 112 might be in the form of an HTTP request, including a basic hash table, possibly compiled into a protocol buffer or other data structure for serializing structured data. In response to the API call made by ad backend server 102, motion data analyzer 112 responds, in flow 7, with a response record to ad backend server 102 containing movement data as well as the originally supplied API call ID argument, which might not be needed if ad backend server 102 can otherwise match up API calls and API responses.

In flow 8, ad backend server 102 sends the content of the API call response, or at least the ad result and the ad ID, to reporting database 110. Optionally, flow 8 may include movement data. Reporting database 110 can be used to generate reports for customers, understand how each ad and ad campaign performed and can be used for the data science aspect to further optimize ad engagement. Instead of storing raw sensor data, motion might be stored as a label, such as a selection from an enumerated list. Reporting database 110 might store, for various labels, corresponding click-through rates (CTR) or other measures of engagement with the ad. The rates might be for a recent period of time, as shown in the example of Table 1.

TABLE 1

| | | | | | Change over |
|---|---|---|---|---|---|
| Category | Action | Label | Count | CTR | baseline CTR |
| Discerned | Walking | WALK | 1000 | 2.3% | 130% |
| User | Running | RUN | 3500 | 1.2% | 20% |
| Motions | Lying Down | LYING | 3000 | 1.6% | 60% |
| Discerned | Typing | TYPE | 1800 | 1.45% | 45% |
| Device | Device on Table | REST | 900 | 0.1% | −90% |
| Activity | Device in Hands | HANDL | 1250 | 4.3% | 330% |
| | Music Playing | MUSIC | 600 | 0.7% | −30% |
| Combined | Hands and Typing | COMB-1 | 721 | 2.2% | 120% |
| Detections | Walking and | COMB-2 | 145 | 2.5% | 150% |
| | Typing | | | | |
| | Music Playing | COMB-3 | 120 | 2.15% | 115% |
| | and Running | | | | |
| | Music Playing | COMB-4 | 450 | 0.3% | −70% |
| | and Lying Down | | | | |

In Table 1, a CTR of 1.00% is used, but other numbers might work instead. The CTR might be determined from a baseline of previously observed ad. The count might be the total number of instances of an ad being served while the user device was reflecting a given label and the CTR for that label might be the percentage of those instances where the user further engaged with the ad, such as be clicking through the ad. From the change over the baseline CTR, promising labels and their corresponding ads can be determined.

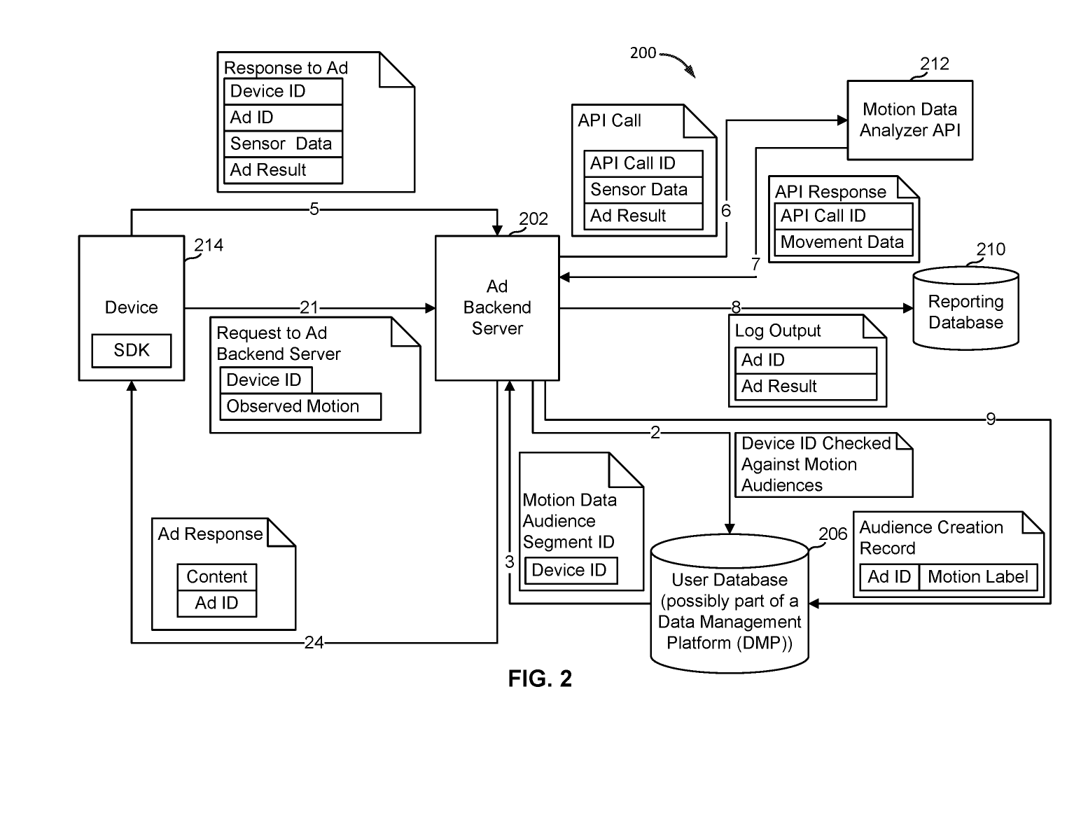

FIG. 2 is a block diagram of another networked system 200 wherein user devices are fitted with program code that collects sensor data that is independent of delivered advertisements. The code may be included in an SDK which allows the device to collect sensor data continuously, periodically, or on another schedule. Using this sensor data, the SDK can produce observed motion data to be sent to request an ad.

In the embodiment of FIG. 2, networked system 200 comprises an ad backend server 202, a user database 206, a reporting database 210, and a motion data analyzer 212. To request an ad, a published app might make a request to ad backend server 202 using code provided to the app developer by the SDK for that purpose. The app (via the SDK code) might send a conditional request for an ad to ad backend server 202, upon which ad backend server 202 provides an ad response in response to the ad request. User device 214 executes the app that includes the SDK code. Although only one is shown, it should be understood that networked system 200 can handle many user devices simultaneously.

As in FIG. 1, the numbered arrows in FIG. 2 indicate flows wherein data elements are passed among the components of networked system 200. A process might start with flow 21, where the app having the SDK code makes an ad request and provides previously recorded observed motion data. The request would include a device ID as well.

In flow 2, ad backend server 202 sends a query to user database 206 to determine if there are records for the user device identified in the request in flow 21. If not, records might be created. If there are records for that user device, the records would include details of one more audience segments associated with the user device. An association of a user device (or some anonymized reference to the user device) might be formed from a history of motion of that user device. The mapping of device IDs based on motion and other information to audience segments might be done based on a stored set of rules that are stored in computer-readable form.

Based on previously gathered observed motion data, a profile of the user of the user device is made. In flow 3, ad backend server 202 obtains audience segment data from the response to the query of user database 206 in flow 2. The reply data indicates the audience segments for the queried device ID. In flow 24, ad backend server 202 sends a message to user device 214 comprising an advertisement in the form of electronic content. This flow 24 appears to user device 214 as a response to the request in flow 21. Ad backend server 202 may select the ad to send based on campaign rules stored in computer-readable form that select among possible ads based on the one or more audiences to which the user device belongs. The message in flow 24 includes an ad ID and the advertisement content, which might be text, an animation, video, interactive program, etc. As an ad is provided to the user device, the user device will execute the code.

Once user device 214 receives the advertisement message, user device 214 can use the advertisement, such as by placing it into an advertising slot of the requesting app, or the like, and then the remainder of the process can be substantially the same as with the ad exchange embodiment of FIG. 1. In the embodiment of FIG. 2, add response does not include motion detection code (MDC) as that function is performed by the SDK. Sensor data from the SDK may still be included in flow 5 as in the embodiment of FIG. 1, but the sensor data would be provided by the SDK instead of the motion detection code within an ad. The example embodiment has used a device ID, though the device ID may be correlated to a user having a user ID if the user is logged in to an app running the SDK or if the user can be otherwise determined.

The “ad result” data element exchanged in flow 5 might be a metric representing whether a user clicked on the ad, which can be representative of, or a proxy for, a measure of engagement. The sensor data might be stored as a hash table that is then compiled into a protocol buffer or other data structure for serializing structured data. The sensor data data structure might be created by user device 214 using the SDK code along with information provided with the ad response. In an alternative embodiment, the sensor data might be omitted from the response to ad in flow 5. In such an embodiment, the observed motion from flow 21 would be used instead of the Sensor Data in the API call of flow 6. The ad result would be reported to the reported database 210 in flow 8, in a call which did not include movement data.

Networked system 200 is similar to networked system 100, but in networked system 200, observed sensor data is collected separately from the delivered advertisement messages. In this case, the sensor data is already available at the user device 214, so it can be included in the ad request in flow 21. As shown, the SDK might be code supplied to app developers that would in turn support the ad request processes. Where the SDK code provides the functionality that monitors sensor data, the observed motion or other measure can be obtained without using an ad exchange server. The data and ad requests are directly transmitted between the device and the ad backend server. In the preferred embodiment, the motion data or other data is isolated from the published app, so that the app publisher does not have access to that data.

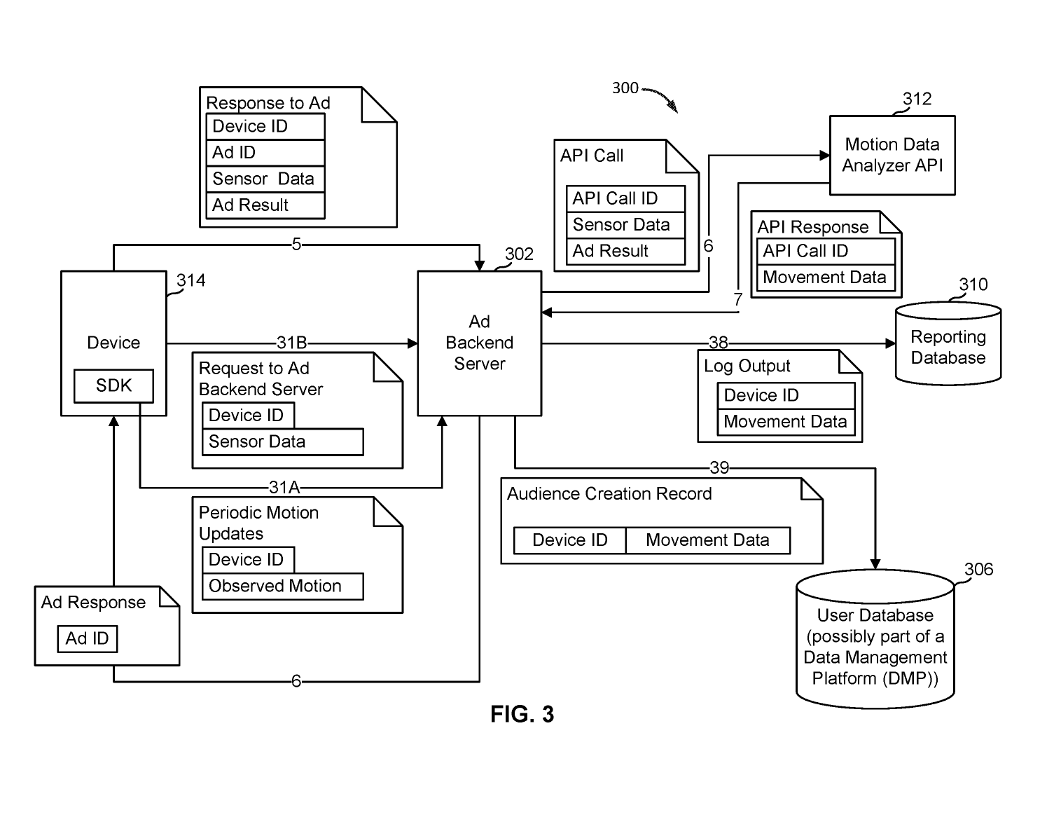

FIG. 3 illustrates another networked system 300, wherein program code observes sensor data over a period of time that is then used for selecting advertisements. Like the networked system of FIG. 2, embedded code gathers sensor data while the enabled app is running and provides the sensor data in flow 31A before or concurrently with an ad request in flow 31B. The embedded code may be provided by, for example, an SDK. However, in this variation, the user device stores sensor data over a period of time and then the SDK code sends data either with an ad request or without an ad request depending on the configuration. When sensor data is sent without an ad request, it may be processed to produce observed motion data which may be used to create audiences on the DMP and to understand user behavior.

In the embodiment of FIG. 3, networked system 300 comprises an ad backend server 302, a user database 306, a reporting database 310, and a motion data analyzer 312, but user database 306 might only be used for storing created audience data. To request ads, a published app might make a request to ad backend server 302 using code provided to the app developer by the SDK for that purpose. User device 314 executes the app that includes the SDK code. Although only one is shown, it should be understood that networked system 300 can handle many user devices simultaneously.

As in the other figures, the numbered arrows in FIG. 3 indicate flows wherein data elements are passed among the components of networked system 300. A process might start with flow 31A, in which the app having the SDK code provides sensor data, perhaps with processing to become observed motion data, and a device identifier to the ad backend server. Note that this occurs even prior to ads being delivered or requested, as the motion data functionality is provided by the SDK code provided to the app. Preferably, the motion data is gathered and sent without providing other areas of the app access to that data. In flow 31B, an ad request is provided in conjunction with the sensor data of flow 31A provided by the SDK code. The ad request may include sensor data or may be accompanied by a concurrent motion update. If the ad request includes its own data, it may be sensor data which has been processed to become observed motion data. In the embodiment shown in FIG. 3, periodic updates include observed motion data while the ad requests use sensor data. This advantageously allows periodic updates to send processed data, minimizing the amount of data transmitted while allowing requests to be generated quickly from sensor data, which may be generated using less processing than observed motion data.

In an embodiment in which the app includes the SDK code, the app, by running the SDK code, provides observed motion data and a device identifier to the ad backend server over an extended time period that can be prior to any ads being delivered. This allows the ad backend server to determine the audience(s) of the user device prior to any ads being delivered, so that the first ad delivered can be to the correct audience. The data can be collected over time, and the observed motion data and device ID sent on a regular cadence. The cadence need not be fixed and can vary based on a number of factors, such as availability of a channel to send the data. The data may be cached so that periodic data may be stored until a channel is available. The data may be processed so that a digest of raw sensor data is sent rather than sending raw sensor data, saving bandwidth.

Flows 6 and 7 in the embodiment of FIG. 3 operate similarly as the embodiment of FIG. 2. Flow 6 may be triggered in response to a periodic motion update (flow 31A), in which case the result field would be omitted and the sensor data would be replaced by observed motion data. Flow 6 may also be in response to a request to ad backend server, in which case the ad result would be omitted. For flows 38 and 39, since there might not be an ad ID, those flows can use a device ID to match up the log outputs and audience creation records, instead of the Ad ID of flows 8 and 9 of FIG. 1 and FIG. 2. Flow 5 operates as in previous embodiments, providing a result (e.g., clicked on) for the ad provided in the Ad response of flow 6. As before, the response to ad may include sensor data as well.

In the embodiment shown in FIG. 3, the SDK code executed as part of the app transmits sensor data to the ad backend server in a request to ad backend server. As explained herein, the ad backend server uses that data to place the user device into one or more audiences and then uses those audiences to determine an ad to serve to the app when the app makes an ad request. In another variation, the app that transmits the observed motion data to the ad backend server need not be the same app that makes the ad request. For example, a first app might execute the SDK code and transmit observed motion data to the ad backend server. The ad backend server operates as before, but there might be a second app running on the user device that sends an ad request to the ad backend server. That second app need not include the SDK code, since the ad backend server already would have sufficient data from the first app. It also might be the case that the second app makes requests via an ad exchange, as in the example of FIG. 1. This is not difficult, as the second app is not being relied on to supply any observed sensor data.

In the case where the user device is running more than one app with the SDK code, the ad backend server might process messages from more than one app on the user device. The ad backend server might receive identical data from more than one app on one user device, but the data might also not be identical. In such cases, the ad backend server could merge the multiple data sets, average them, use only the most recent data set, or perform other operations to deal with multiple sources of observed motion data observed from the same device. In another embodiment, the multiple versions of the running SDK code may be aware of each other and coordinate to send only one version of the data, possibly by a service running on the device.

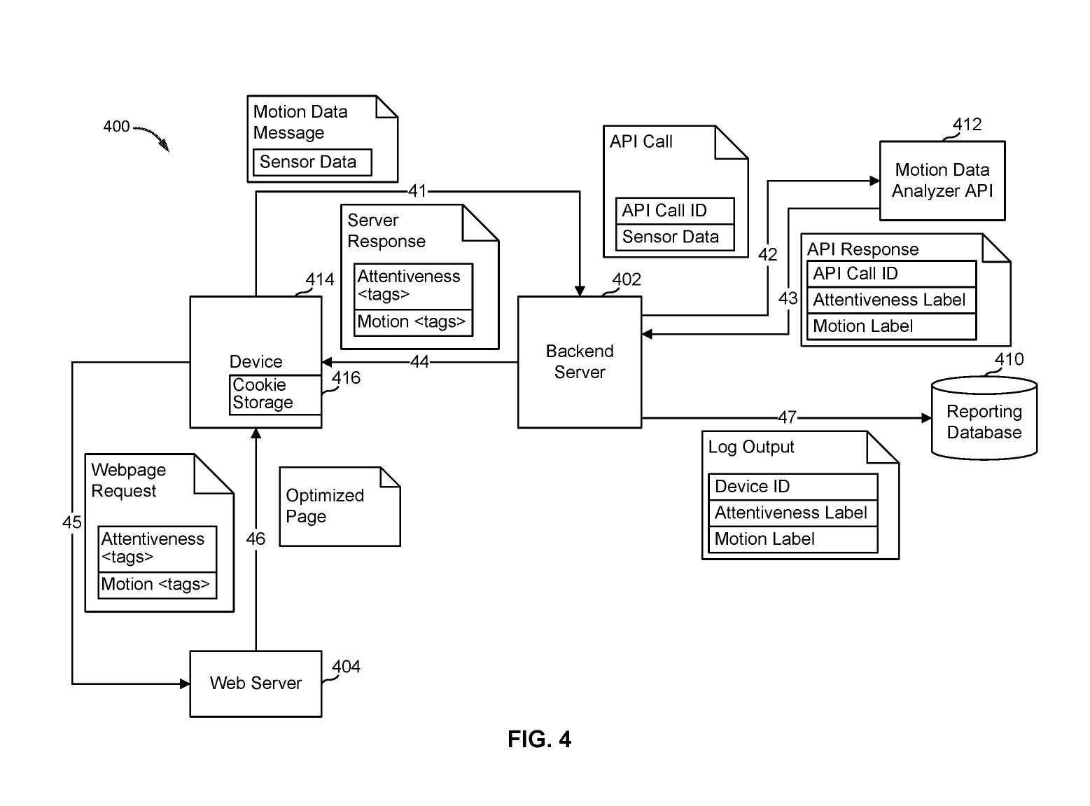

FIG. 4 is a block diagram of yet another networked system 400, wherein program code observes sensor data, including motion data, over a period of time. The sensor data is used to determine how to present information and provided in a request to a web server. For example, if a motion sensor system detects that a user is relatively inactive, it can show a website with full details with the assumption that the user has time to currently focus on the website. However, if motion sensor system detects that a user is relatively active, such as out running, it would show the website in a simpler form, allowing the user to absorb the content with less attention. This could be applicable to different formats, such as for mobile devices, phones, tablets, some laptops, and other devices capable of sensing user activity.

The functionality might be implemented by providing content providers with information about the current consumers of the content, such as sensor data including motion data, and allow for tailoring of websites and other content based on a deemed attentiveness level for the user. The device may provide the sensor information to the content provider via an embedded tag, such as a Javascript™ tag in the request for a webpage. Based on the observed motion, different tags will be provided to the website and, based on those tags, the website will be rendered differently for the user depending on the different tags. In one embodiment, the tags provided to the website might indicate what activity (e.g., walking, running, lying on the couch) the user is engaged in. In another embodiment, the tags may instead indicate a deemed attentiveness level based on activity or raw sensor data. For example, if someone is walking with their mobile device while browsing a mobile website, then the website might offer a simplified version of the website or offer larger text and buttons that are easier to push. If a person is running with their device, a very simple page with a “read later or remind me when I am done running” message might be offered. If a person is detected at home lounging on a sofa, then the website might render a more complete version of the website and perhaps focus the experience around video.

As illustrated in the block diagram of FIG. 4, a networked system correlates user device sensor data with external data to derive a deemed attentiveness level. The networked system uses the deemed attentiveness level to modify presentations. The networked system might comprise network-connected servers, user devices, and databases. In these examples, where only one instance of an object is shown, it should be understood that there might be multiple such instances, unless otherwise indicated. Deemed attentiveness level might be determined from sensor data, movement type, location, and/or current user activity.

As shown in FIG. 4, a networked system 400 comprises a backend server 402, interfaces to a web server 404, a reporting database 410, and a motion data analyzer 412 (which might be accessed by backend server 402 via an API). Backend server 402 might also handle ad management in addition to processing motion data for web content providers. Also shown is a user device 414. Although only one is shown, it should be understood that networked system 400 can handle many user devices simultaneously.

In a particular process, indicated by the numbered arrows in FIG. 4, data elements are passed among the components of networked system 400. The data elements passed between components can comprise the data indicated and possibly other data. The data might be passed in messages, API calls, writing to shared memory, or other methods of interprocess and/or inter-component communications. A process might start with flow 41, where user device 414 sends sensor data including motion data to backend server 402.

Backend server 402 obtains the sensor data and provides it to motion data analyzer 412 in flow 42, with an API call ID that can be used to match up replies with requests, though other mechanisms of matching replies with requests may be used. Based on previously gathered sensor data, a profile of the user of the user device might be made by mapping raw sensor data to motion categories or labels, and possibly using external data as well. For example, backend server 402 might provide motion data analyzer 412 with sensor-based raw motion data that motion data analyzer 412 returns as being characterized as running motions, encoded in a motion label. Alternatively, the motion data analyzer 412 might return a deemed measure of attentiveness encoded in an attentiveness label, indicating how much attention the user has for a web page, based on the sensor data. The data structure containing the sensor data might be created by user device 414 using a JavaScript™ portion of a webpage or it could also be generated by SDK code in user device 414. Flow 42 might be an API call with arguments of an API call ID and sensor data. The data sent to motion data analyzer 412 might be in the form of an HTTP request, including a basic hash table, possibly compiled into a protocol buffer or other data structure for serializing structured data.

In response to the API call made by backend server 402, motion data analyzer 412 responds (flow 43) with a response record to backend server 402 containing movement data, such as a motion label, as well as the originally supplied API call ID argument, which might not be needed if backend server 402 can otherwise match up API calls and API responses. The response may include an attentiveness label in addition to or as an alternative to the motion data.

In flow 44, backend server 402 sends the motion labels or attentiveness labels, or tags representing those labels, to user device 414.

Then, when user device 414 sends a request for a webpage in flow 45 to web server 404, it can include the provided tags, which web server 404 would use to control the presentation of the web page optimized for the user's current activity in flow 46.

In flow 47, backend server 402 sends the content of the API call response, or at least the device ID and one of the motion label and attentiveness label, to reporting database 410. Reporting database 410 can be used to generate reports for customers, understand how each ad and ad campaign performed, and can be used for the data science aspect to further optimize ad engagement. Instead of storing raw sensor data, motion labels or tags might be stored as a label, such as a selection from an enumerated list.

In another variation, the process from flow 41 might involve the user device 414 sending a request for a website to web server 404 which processes the sensor data to produce a tailored presentation of a web site. This web server 404 might be operated independently of networked system 400 and thus networked system 400 would need to take into account constraints imposed by that independence, such as not having control over the structure and operations and data of web server 404. When user device 414 requests a web page, the request would include a device ID, which would distinguish the requesting user device from other user devices that might also connect to web server 404.

In another variation, an initial request to a web server may be made before attentiveness or motion tags are available. In such an embodiment, once attentiveness or motion tags become available, the user interface may prompt the user to ask if the user would like a simplified or otherwise tailored web page. This prompt may include flashing the screen or drawing a prompt over the screen that “greys out” the underlying web page, allowing a user whose deemed level of attentiveness is low to easily focus on the prompt.

Once the deemed level of attentiveness of the user has been determined, this level of attentiveness may be used across websites, for example by using a cookie that is accessible by multiple websites. This cookie might be stored in a local cookie storage 416, possibly along with other cookies. This would allow user device 414 to perform the selection of presentation characteristics locally.

In another variation, user device 414 may process the sensor data on board to produce either attentiveness or motion tags, without making any requests off the device. The device would then provide the attentiveness or motion tags to the web server as in the embodiment of FIG. 4.

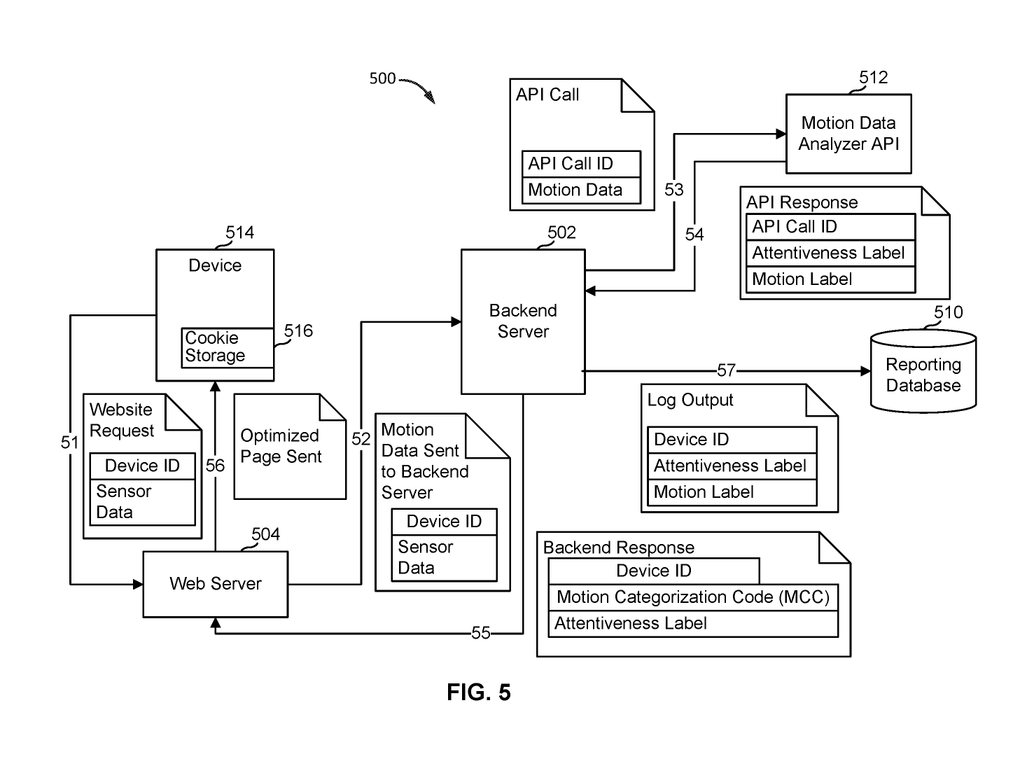

FIG. 5 is a block diagram of another networked system, wherein program code observes sensor data, including motion data, over a period of time. The sensor data is provided to the web server and used for determining how to present information.

As shown in FIG. 5, a networked system 500 comprises a backend server 502, interfaces to a web server 504, a reporting database 510, and a motion data analyzer 512 (which might be accessed by backend server 502 via an API). Backend server 502 might also handle ad management in addition to processing sensor data for web content providers. Also shown is a user device 514. Although only one is shown, it should be understood that networked system 500 can handle many user devices simultaneously.

In a particular process, indicated by the numbered arrows in FIG. 5, data elements are passed among the components of networked system 500. The data elements passed between components can comprise the data indicated and possibly other data. The data might be passed in messages, API calls, writing to shared memory, or other methods of interprocess and/or inter-component communications. A process might start with flow 51, where user device 514 sends a request for a website to web server 504. This web server 504 might be operated independently of networked system 500 and thus networked system 500 will need to take into account constraints imposed by that independence, such as not having control over the structure and operations and data of web server 504. When user device 514 requests a web page, the request would include a device ID to distinguish the requesting user device from other user devices that might also connect to web server 504. The request would also include sensor data including motion data. In alternative embodiments, the sensor data may be sent separately from the request.

In flow 52, backend server 502 obtains the sensor data, associated with a device ID, and provides it to motion data analyzer 512, with an API call ID, used to match replies with requests. Based on previously gathered sensor data, a profile of the user of the user device 514 might be made by mapping raw sensor data to motion categories or labels, and possibly using external data as well. For example, backend server 502 might provide motion data analyzer 512 with sensor-based raw motion data that motion data analyzer 512 returns as being characterized as running motions in a motion label. Alternatively or additionally, the response might include a deemed measure of attention encoded in an attentiveness label. The data structure containing the sensor data might be created by user device 514 using the JavaScript™ portion of a webpage or it could also be generated by SDK code in user device 514.

Flow 53 might be an API call with arguments of an API call ID and motion data. In some embodiments, it may also include an ad result record. The data sent to motion data analyzer 512 might be in the form of an HTTP request, including a basic hash table, possibly compiled into a protocol buffer or other data structure for serializing structured data. In response to the API call made by backend server 502, motion data analyzer 512 responds (flow 54) with a response record to backend server 502 containing movement data and/or attentiveness data as well as the originally supplied API call ID argument, which might not be needed if backend server 502 can otherwise match up API calls and API responses.

In flow 55, backend server 502 sends motion a motion categorization code or an attentiveness label to the web server with the device ID, so that web server 504 can serve up the appropriate format webpage (flow 56).

In flow 57, backend server 502 sends the content of the API call response, or at least the motion data and the device ID, to reporting database 510. Reporting database 510 can be used to generate reports for customers, understand how each ad and ad campaign performed and can be used for the data science aspect to further optimize ad engagement. Instead of storing raw sensor data, motion might be stored as a label, such as a selection from an enumerated list.

In another variation, an initial request to a web server may be made before attentiveness or motion tags have been retrieved by the web server. In such an embodiment, once attentiveness or motion tags become available, the user interface may prompt the user to ask if the user would like a simplified or otherwise tailored web page. This prompt may include flashing the screen or drawing a prompt over the screen, allowing a user whose deemed level of attentiveness is low to easily focus on the prompt.

Once the deemed level of attentiveness of the user has been determined by a web server, this level of attentiveness may be used across websites, for example by using a cookie that is accessible by multiple websites. It may also be communicated directly between websites, with some mechanism to identify devices between websites. This cookie might be stored in a local cookie storage 516, possibly along with other cookies. This would allow user device 514 to perform the selection of presentation characteristics locally.

According to one embodiment, the techniques described herein are implemented by one or generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

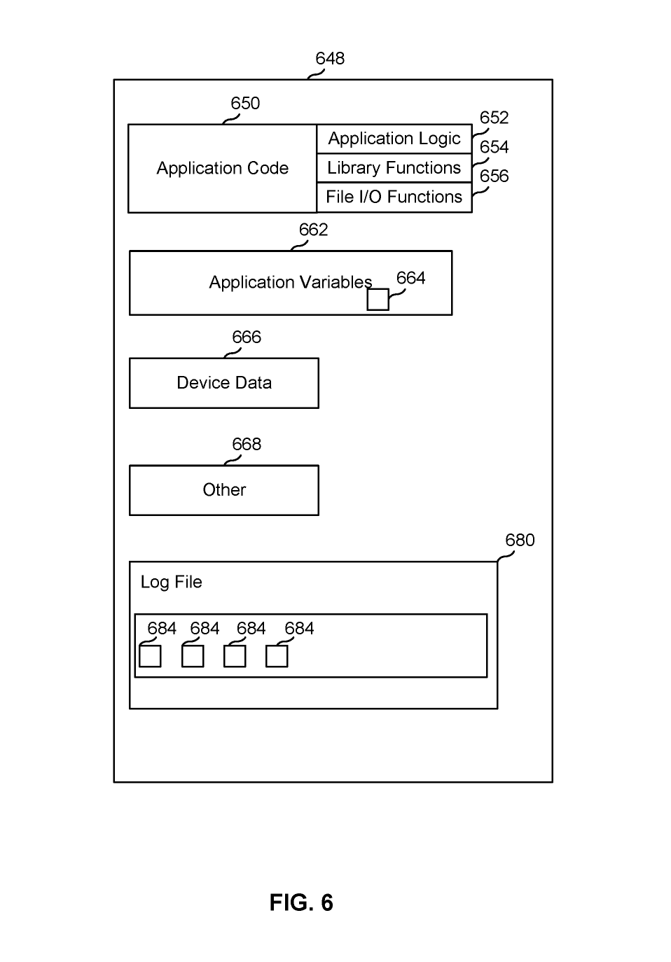

FIG. 6 illustrates an example of memory elements that might be used by a processor to implement elements of the embodiments described herein. For example, where a functional block is referenced, it might be implemented as program code stored in memory. FIG. 6 is a simplified functional block diagram of a storage device 648 having an application that can be accessed and executed by a processor in a computer system. The application can be one or more of the applications described herein, running on servers, clients or other platforms or devices and might represent memory of one of the clients and/or servers illustrated elsewhere. Storage device 648 can be one or more memory devices that can be accessed by a processor and storage device 648 can have stored thereon application code 650 that can be configured to store one or more processor readable instructions. The application code 650 can include application logic 652, library functions 654, and file I/O functions 656 associated with the application.

Storage device 648 can also include application variables 662 that can include one or more storage locations configured to receive input variables 664. The application variables 662 can include variables that are generated by the application or otherwise local to the application. The application variables 662 can be generated, for example, from data retrieved from an external source, such as a user or an external device or application. The processor can execute the application code 650 to generate the application variables 662 provided to storage device 648.

One or more memory locations can be configured to store device data 666. Device data 666 can include data that is sourced by an external source, such as a user or an external device. Device data 666 can include, for example, records being passed between servers prior to being transmitted or after being received. Other data 668 might also be supplied.

Storage device 648 can also include a log file 680 having one or more storage locations 684 configured to store results of the application or inputs provided to the application. For example, the log file 680 can be configured to store a history of actions.

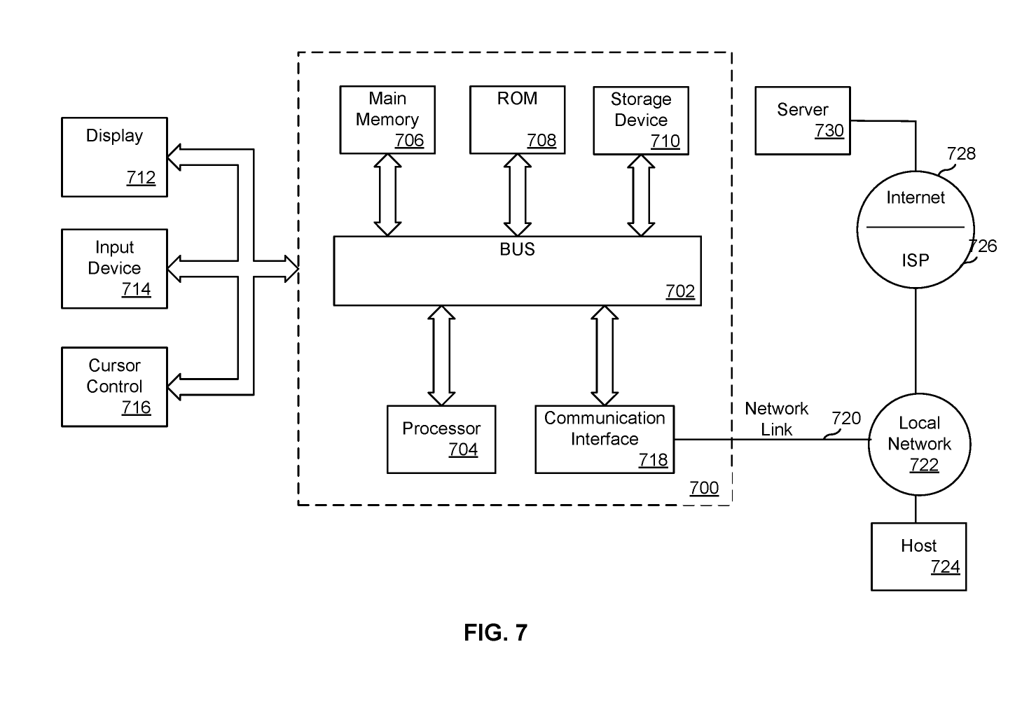

FIG. 7 is a block diagram that illustrates a computer system 700 upon which an embodiment of the invention may be implemented. Computer system 700 includes a bus 702 or other communication mechanism for communicating information, and a processor 704 coupled with bus 702 for processing information. Processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a computer monitor, for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a network connection. A modem or network interface local to computer system 700 can receive the data. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, and/or stored in storage device 710, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A method of serving content to a user device having sensors that sense movement and other characteristics of the user device, the method comprising:
gathering sensor data from the user device;
analyzing the sensor data to determine an activity of a user of the user device; and
selecting a presentation format in which to present content to the user based on the determined activity of the user.

2. The method of claim 1, wherein gathering sensor data from the user device comprises sending the sensor data from the user device to a backend server, wherein analyzing the sensor data is performed using the backend server and a motion data analyzer, and further comprising:
identifying motion labels based on the sensor data;
sending the motion labels from the backend server to the user device; and
sending a representation of the motion labels from the user device to a content provider of the content to be presented to the user, wherein the representation is usable for selecting the presentation format.

3. The method of claim 1, wherein gathering sensor data from the user device comprises sending the sensor data from the user device to a content provider of the content to be presented to the user and sending at least a portion of the sensor data from the content provider to the backend server, wherein analyzing the sensor data is performed using the backend server and a motion data analyzer, and further comprising:
identifying motion labels based on the sensor data;
sending the motion labels from the backend server to the content provider; and
using a representation of the motion labels at the content provider for selecting the presentation format.

4. The method of claim 1, wherein the sensor data is data from one or more of a gyroscope sensor for detecting and/or measuring rotation, an accelerometer for detecting and/or measuring movement, a GPS element for detecting and/or measuring location, a barometer for detecting and/or measuring atmospheric pressure, or a thermometer for detecting and/or measuring temperature.

5. The method of claim 4, further comprising:
sensing, using wherein the barometer, a current atmospheric pressure;
determine, from the current atmospheric pressure, altitude where the user device is currently located; and
selecting an advertisement based on the altitude or providing a notification to the user via the user device, wherein the notification is based on the altitude and/or changes in the current atmospheric pressure.

6. The method of claim 1, wherein gathering sensor data from the user device comprises sending the sensor data from the user device to a backend server, wherein analyzing the sensor data is performed using the backend server and a motion data analyzer, and further comprising:
identifying at least one audience segment based on the sensor data; and
selecting an ad using at least the audience segment for presentation on the user device.

7. The method of claim 6, wherein the sensor data is sent from the user device to the backend server periodically, the backend server updating the at least one audience segment based on the sensor data.

8. The method of claim 6, wherein the sensor data used to determine the at least one audience segment uses includes sensor data indicating movement and sensor data indicating location.

9. The method of claim 6, wherein the ad is presented on the user device, the ad including a script to obtain additional sensor data and an indication of engagement with the ad, and further comprising:
sending the additional sensor data and indication of engagement with the ad to a reporting database.

10. The method of claim 1, further comprising:
identifying a deemed level of attentiveness based on the sensor data;
sending the deemed level of attentiveness from the backend server to the user device; and
sending a representation of the deemed level of attentiveness from the user device to a content provider of the content to be presented to the user, wherein the representation is usable for selecting the presentation format.

11. The method of claim 10, further comprising:
presenting a prompt on the user device to allow accepting the presentation format.

12. The method of claim 11, further comprising:
after acceptance of the presentation format, providing the deemed level of attentiveness to a second content provider, the second content provider providing additional content based on the deemed level of attentiveness.

13. A non-transitory computer-readable storage medium having stored thereon executable instructions that, when executed by one or more processors of a computer system, cause the computer system to at least:
execute motion collection code in response to an application on a user device invoking the motion collection code;
record sensor data from sensors of the user device, wherein recording is done to a memory space not accessible to the application;
transmit recorded sensor data to a backend server;
analyze the sensor data to determine an activity of a user of the user device; and
select a presentation format in which to present content to the user based on the determined activity of the user.

14. The non-transitory computer-readable storage medium of claim 13, wherein the executable instructions are in the form of program code embedded into the application by way of a system development kit.
